(19) United States
(12) Patent Application Publication
(10) Pub. No.: US 2006/0277131 A1
(43) Pub. Date: Dec. 7, 2006

(54) HYBRID FINANCING STRUCTURE FOR RENEWABLE POWER FACILITIES

(76) Inventors: Richard M. Bacon, Tenafly, NJ (US); Charles Cardall, Kensington, CT (US); Yoichi Katayama, Yokohama-shi (JP)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/421,733

(22) Filed: Jun. 1, 2006

Related U.S. Application Data
(60) Provisional application No. 60/686,927, filed on Jun. 1, 2005.

(51) Int. Cl. G06Q 40/00

(52) U.S. Cl. 705/35

(57) ABSTRACT

The present invention provides a hybrid financing structure for renewable power facilities that reduces the cost of power supplied from such facilities. In a preferred embodiment, the hybrid financing structure combines low cost financing, e.g., bonds, available to governmental entities, e.g., municipalities, with tax benefits and similar benefits available to private entities to lower the cost of power supplied from a renewable power facility. The renewable power facility is owned and operated by a private company to take advantage of tax benefits and similar benefits available to the private sector. To further reduce costs, a municipality prepays for power supplied from the facility using low cost financing, e.g., tax exempt bonds, available to the municipality. The hybrid financing structure also includes a production tracking account that reduces risk associated with prepayment of fluctuating renewable power supplies for the municipality by notionally tracking actual power production against predicted levels.

### RELATED APPLICATION INFORMATION

This application claims the benefit of Provisional Application Ser. No. 60/686,927, filed on Jun. 1, 2005.

### FIELD OF THE INVENTION

The present invention relates to power facility financing structures and, more particularly to a hybrid financing structure for renewable power facilities that reduces the cost of power.

### BACKGROUND OF THE INVENTION

Environmental degradation, national security, and economic growth are some of the issues fueling the push toward renewable sources of energy such as wind energy and solar energy.

Today, renewable power is realized by many as a promising clean energy resource that can serve as an alternative to fossil-fuel-generated electricity. In 1999, for example, worldwide wind-generated electricity has been estimated to have exceeded 10,000 megawatts, approximately 16 billion kilowatt-hours of electricity. It has also been estimated that wind energy could provide 20% of the United States electricity with wind turbines installed on less than 1% of the nations' land area.

Although pollution free and more affordable and available today, renewable power has its drawbacks. For example, solar energy and wind power suffers from a lack of energy density. Because renewable energy is a very diffuse energy source, large numbers of renewable power generators on large areas of land are required to produce useful amounts of heat or electricity. As a result, renewable power facilities tend to be more costly to build on a cost per kw-hour basis under current financing models than fossil fuel power plants. Consumers tend to pay more for the electricity from renewable power facilities as a result.

Therefore, it would be desirable to provide an improved financing structure for the development of renewable power facilities that reduces the cost of power supplied from such facilities.

### SUMMARY OF THE INVENTION

The present invention provides a hybrid financing structure for renewable power facilities that reduces the cost of power supplied from such facilities.

In a preferred embodiment, the hybrid financing structure combines low cost financing, e.g., bonds, available to governmental entities, e.g., municipalities, with tax benefits and similar benefits available to private entities to lower the cost of power supplied from a renewable power facility. The renewable power facility is preferably owned and operated by a private company to take advantage of tax depreciation benefits, and credits including production tax credits available from the Federal government and renewable energy tax credits and green credits available in various State and local jurisdictions, and subsides. To further reduce costs, a municipality prepays for power supplied from the facility using low cost financing, e.g., bonds, available to the municipality. The prepayment of power allows the private company to refinance a construction loan for the facility without the need for a higher interest commercial loan, e.g., from a bank. As a result, the costs associated with making higher interest payments on a commercial loan can be eliminated, thereby further reducing the cost of power.

In the preferred embodiment, the hybrid financing structure includes a production tracking account that reduces risk associated with prepayment of fluctuating renewable power supplies for the municipal power purchaser. The production tracking account reduces risk by providing debits or credits to the power purchaser when power output from the facility is above or below predicted levels.

Therefore, the hybrid financing structure provides the power purchaser with many of the benefits of self-ownership, combined with lower power costs resulting from private sector tax and similar benefits, but with less than normal risk.

Other methods, features and advantages of the invention will be or will become apparent to one with skill in the art upon examination of the following figures and detailed description.

### BRIEF DESCRIPTION OF THE DRAWINGS

FIG. 1 is a diagram showing a hybrid financing structure for a renewable energy project according to an embodiment of the invention.

FIG. 2 is a flow diagram of a hybrid financing structure for a renewable power facility.

### DETAILED DESCRIPTION

The present invention provides a hybrid financing structure for renewable power facilities that reduces power costs and reduces risk associated with fluctuating power production and other risks. More particularly, the financing structure involves bond financing by a municipality or other governmental entity to prepay for the purchase of power. The proceeds from the prepaid power purchase may be used by the developer of the facility to, among other things, refinance a private sector construction loan that was used to fund construction of the power facility. The renewable power facility may be a wind farm supplying electricity to a municipal utility, solar arrays supplying electricity to the State or other municipal entities, or other renewable power facility which can benefit from tax benefits and similar benefits. The price of power is lowered by combining a number of price reduction vehicles, including lower cost debt financing, tax benefits and other benefits. The financing structure results in the municipal power purchaser gaining many of the benefits of self-ownership (and can include an option to purchase the facility), combined with lower costs resulting from certain private sector tax benefits, but with less than normal risk.

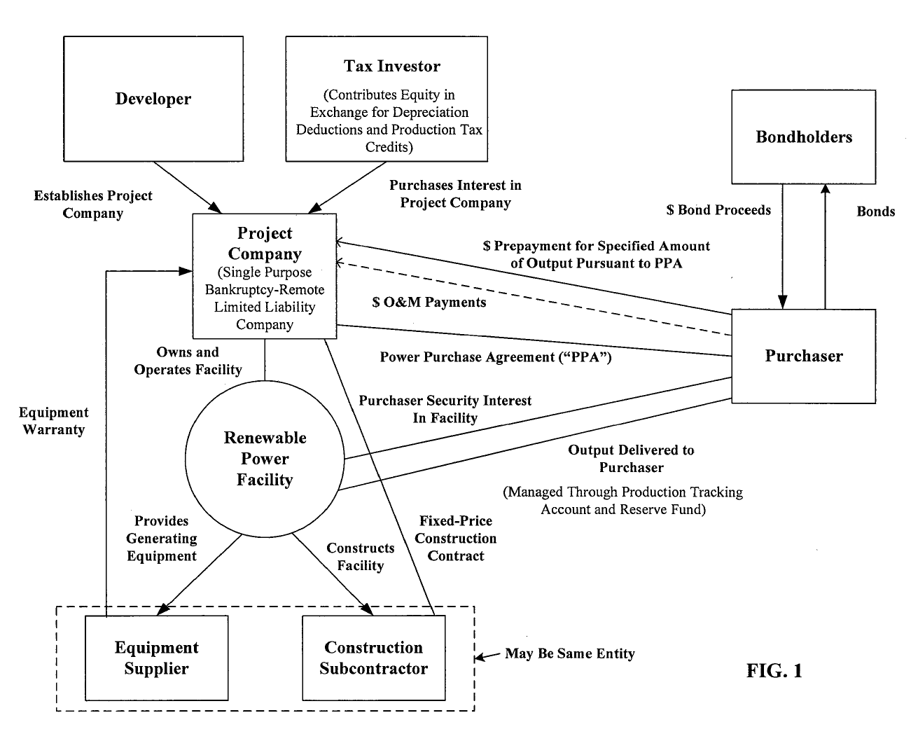

A diagram illustrating a hybrid financing structure according to a preferred embodiment is provided in FIG. 1. Preferably, the project owner and seller of power (the “Project Company”) is a special purpose, bankruptcy remote, limited liability company. The renewable power facility (the “Facility”) is owned and operated by the Project Company. In the diagram, the “Purchaser” of power from the Facility is preferably a municipality, or other similar state or local governmental entity with the power to finance through low cost debt, e.g. bonds based on its credit. The proceeds of the debt are used to prepay the purchase of power from the Facility.

The Purchaser and the Project Company enter into a long-term power purchase agreement (the “Power Purchase Agreement” or “PPA”) providing for prepayment by the Purchaser of a specified amount of electrical output from the Facility for each year during the term of the PPA (“Prepayment”). The purchased output for each year during the term of the PPA and the portion of the prepayment allocable to the purchased output for such year will be set forth in an allocation schedule (the “Allocation Schedule”) attached to the PPA. Execution of the PPA is a precondition to obtaining private sector construction loan financing for the Facility, and the term of the PPA may be extended or shortened, as explained below.

The Facility is preferably constructed by an experienced renewable project developer (the “Developer”). The Developer and the construction subcontractor and supplier (the “Supplier”) of various power generator equipment (the “Generators”) enter into a supply and installation agreement pursuant to which the Supplier supplies and installs the Generators on a fixed-price, turn-key basis. The Supplier and Project Company enter into various agreements including: (1) a long term warranty and acceptance test agreement (the “Warranty Agreement”) for a specified term, pursuant to which the Supplier provides a warranty (the “Warranty”) regarding performance of the Generators, and (2) a maintenance and service agreement for the Facility for the term of the PPA. Each of these agreements must be acceptable to the Purchaser.

Preferably, an interest in the Project Company is purchased by one or more investors (the “Tax Investor”) able to take advantage of tax depreciation benefits (“TDBs”), and credits (“Credits”) including production tax credits from the Federal government and renewable energy tax credits and green credits available from various State and local jurisdictions, and subsidies (“Subsidies”). The Tax Investor and Developer (as Project Company shareholder) enter into an interest sale and purchase agreement pursuant to which Tax Investor will purchase a specified percentage of the Project Company. Project Company equity (the “Equity”) will consist of (i) Developer contributed capital, plus (ii) an amount equal to the value of the TDBs, Credits and Subsidies generated by the Facility. The contributed value associated with the TDBs, Credits and Subsidies will serve to reduce the Prepayment to the extent negotiated with the Purchaser.

The term “Green Credits” means, to the extent available under applicable State, Federal or local law, any and all tradable credits, benefits, emissions reductions, offsets and allowances resulting from the avoidance of the emission of any gas, chemical, or other substance to the air, soil or water attributable to the Facility, including any reporting or trading rights associated therewith.

Therefore, the hybrid financing structure according to the preferred embodiment combines low cost financing available to the municipal Purchaser with tax benefits and similar benefits available to private entities, e.g., the Tax Investor, to lower the cost of power supplied from the Facility.

To take advantage of low cost financing, e.g., tax exempt bonds, available to the Purchaser prepays for power from the Facility for the term of the PPA. The Prepayment allows the Project Company to refinance the construction loan used to find construction of the Facility without the need for a high interest long term commercial loan, e.g., from a bank. As a result, the costs associated with making higher interest payments on a commercial loan can be eliminated. Alternatively, the Project Company may decide to refinance the construction loan using a commercial loan and use the Prepayment for another purpose. However, the Project Company cannot charge the Purchaser a premium to cover the costs associating with higher interest payments on the commercial loan because the Purchaser made the Prepayment available to the Project Company.

Preferably, the Purchaser uses tax exempt debt to finance the Prepayment of power from the Facility. Tax exempt debt is typically available to a municipality when the municipality acts as a utility that unloads power from the Facility onto its power grid. In some cases, tax exempt debt may not be available to the municipality, e.g., when the municipality uses the power internally for its own benefit instead of acting as a public utility. In these cases, the municipality can still utilize low costs financing, e.g., taxable bonds, compared to commercial bank loans, based on the credit.

To take advantage of tax benefits and similar benefits available to the private sector, the Project Company is preferably privately owned and operated.

Power Purchase Agreement

The PPA will, among other things, provide (i) for the purchase and delivery of certain specified electrical output produced by the Facility as set forth in the Allocation Schedule, and (ii) that upon Completion and placement into service of the Facility, bonds will be issued by the Purchaser, the proceeds of which will be used to prepay for power under the PPA.

Renewable resource risk is addressed through an account established under the PPA (the “Production Tracking Account”) to notionally track actual electrical output to the extent that it is less or greater than a mutually agreed targeted production amount specified on the Allocation Schedule (the “Production Target”) to the extent that such variation in electrical output is fairly attributable to unanticipated events. During any applicable measurement period, production of electricity by the Facility exceeding the Production Target shall be deemed production excess (the “Production Excess”) and that which is less than the Production Target is deemed production deficit (the “Production Deficit”). A notional reserve fund is established within the Production Tracking Account (the “Reserve Fund”) to notionally track a mutually agreed portion of any Production Excess as a notional credit (the “Reserve Fund Credit”). The Production Tracking Account and the Reserve Fund are more fully described below.

Events of Default and Remedies

The PPA will include several Events of Defaults, e.g., failure by the Project Company to perform any material obligation under the PPA. Subject to certain limitations, upon the occurrence of a Project Company Event of Default, the Purchaser may (i) terminate the PPA or (ii) exercise its rights under a first priority security interest and lien on all tangible and intangible assets related to the Facility. However, any failure by the Facility to produce electrical output to meet the Production Target shall be administered through the Production Tracking Account and the adjustment of the term of the PPA; and any failure of the Generators to produce agreed upon electricity in accordance with specified parameters shall be administered through the Warranty Agreement below.

Equipment Warranty

Pursuant to the Warranty Agreement, the Supplier will guarantee a certain power curve, as well as availability. An example of a power curve for a wind generator is that at a certain wind speed, the wind generator will produce a certain electrical output. If the Generators do not meet the power curve, the Supplier will pay liquidated damages. If the available requirements are not met, the Supplier will be obligated to pay the Project Company an amount calculated to approximately make up the difference. The forgoing payments shall be transferred to the Purchaser to the extent necessary to satisfy the Project Company's obligations under the PPA.

Tariffs

Two distinct tariffs are applicable at different times and for different purposes under the PPA. The operation and maintenance tariff (the “O&M Tariff”) will be a mutually agreed fixed amount, subject to a mutually agreed inflation adjustment mechanism, in respect of costs associated with operating and maintaining the Facility over the life of the PPA. The base tariff (the “Base Tariff”) will be a mutually agreed KW per hour amount fixed over the life of the PPA.

Prepayment Price

The prepayment price (the “Prepayment Price”) will be the sum of the mutually agreed (i) discounted present value of the Base Tariff, and (ii) the development fee payable to the Developer. The applicable discount rate will be mutually agreed by the Purchaser and the Project Company.

Production Tracking Account

During any applicable measurement period, notionally (i) to the extent the Production Tracking Account contains debits, any Production Excess will be delivered to the Purchaser at no additional charge, reducing such debits by a corresponding amount, (ii) to the extent the Production Tracking Account contains credits, any Production Deficit shall serve to reduce such credits by a corresponding amount, (iii) to the extent the Production Tracking Account contains no debits, Production Excess corresponding to the Reserve Fund Credit amount will be delivered to the Purchaser at no charge and the Reserve Fund shall be credited by a corresponding amount; provided, however, credits in the Reserve Fund shall in no event exceed the Reserve Fund Amount, (iv) to the extent the Reserve Fund contains credits, any Production Deficit shall serve to reduce credits in the Reserve Fund by a corresponding amount, and (v) to the extent the Reserve Fund contains the Reserve Amount, the Purchaser has the option of purchasing Production Excess for such period at the Base Tariff. If the Purchaser chooses not to purchase the Excess Production in (v), the Project Company may sell the Excess Production to other consumers if the facility is able to hookup to a grid supplying power to the other consumers, or the Excess Production may be delivered to the Purchaser at no additional charge and serve to shorten the term of the PPA.

To the extent debits exist in the Production Tracking Account, the term of the PPA will be extended until the corresponding amount of electricity is delivered at the O&M Tariff to the Purchaser. To the extent that credits exist in the Reserve Fund, the term of the PPA will be determined by giving effect to the Production Excess already delivered

An exemplary application of the Production Tracking Account will now be given.

First, the Purchaser and the Project Company mutually agree on predicted power output from the Facility during the term of the PPA. For the example of a wind farm, the predicted power output may be based on estimations of wind speeds in the area and equipment performance during the term of the PPA. Wind speeds may be estimated by measuring wind patterns in the area over time using anemometers. Equipment performance may be estimated by performing tests on the equipment.

The predicted power output may be used to establish a base amount and the Production Target may be set as a percentage of the base amount. In this particular example, the Production Target is set at 90% of the base amount (i.e., 90% of the predicted power output), and the term of the PPA is ten years.

The Production Tracking Account tracks the actual production output of the Facility against the Production Target (90% base in this particular example).

At a particular time during the term of the PPA, a net credit in the Production Tracking Account would indicate the amount that actual production exceeds the Production Target up to that time. For example, a net credit of 10% base would indicate that actual production is at 100% base (100% of the predicted power) up to that time. The credit would also serve to offset any future Production Deficit during a subsequent measurement period by reducing the credit by the corresponding amount.

Conversely, a net debit in the Production Tracking Account would indicate the amount that actual production is below the Production Target up to that time. For example, a net debit of 10% base would indicate that actual production was at 80% base (80% of the predicted power) up to that time. The debit would also serve to offset any future Production Excess during a subsequent measurement period by reducing the debit by the corresponding amount.

The Reserve Fund Credit may equal the net credit up to the Reserve Fund Amount (e.g., 10% base). Production Excess corresponding to the Reserve Fund Credit would be delivered to the Purchaser at no additional charge. To the extent that Credit exists in the Reserve Fund, the term of the PPA would be adjusted to give effect to the Production Excess already delivered to the Purchaser. For example, if the Reserve Fund Credit is at 10% base at year 9 of the PPA, then the term of the PPA would terminate early to give effect to the Production Excess already delivered to the Purchaser. If there is a debit in the Production Tracking Account at the end of year 10 of the PPA, then the term of the PPA would be extended until an amount of power corresponding to the debit is delivered to the Purchaser. This would ensure that the Purchaser receives all the contracted power in the PPA.

Casualty

Upon the occurrence of a total casualty with respect to a Generator during the term of the PPA, the Project Company will pay to the Purchaser an amount equal to the application “Termination Value” of such Generator. The Project Company will obtain insurance on the Facility in amounts sufficient, from time to time, to fund payments of Termination Value, assuming that all of the Generators suffer a casualty.

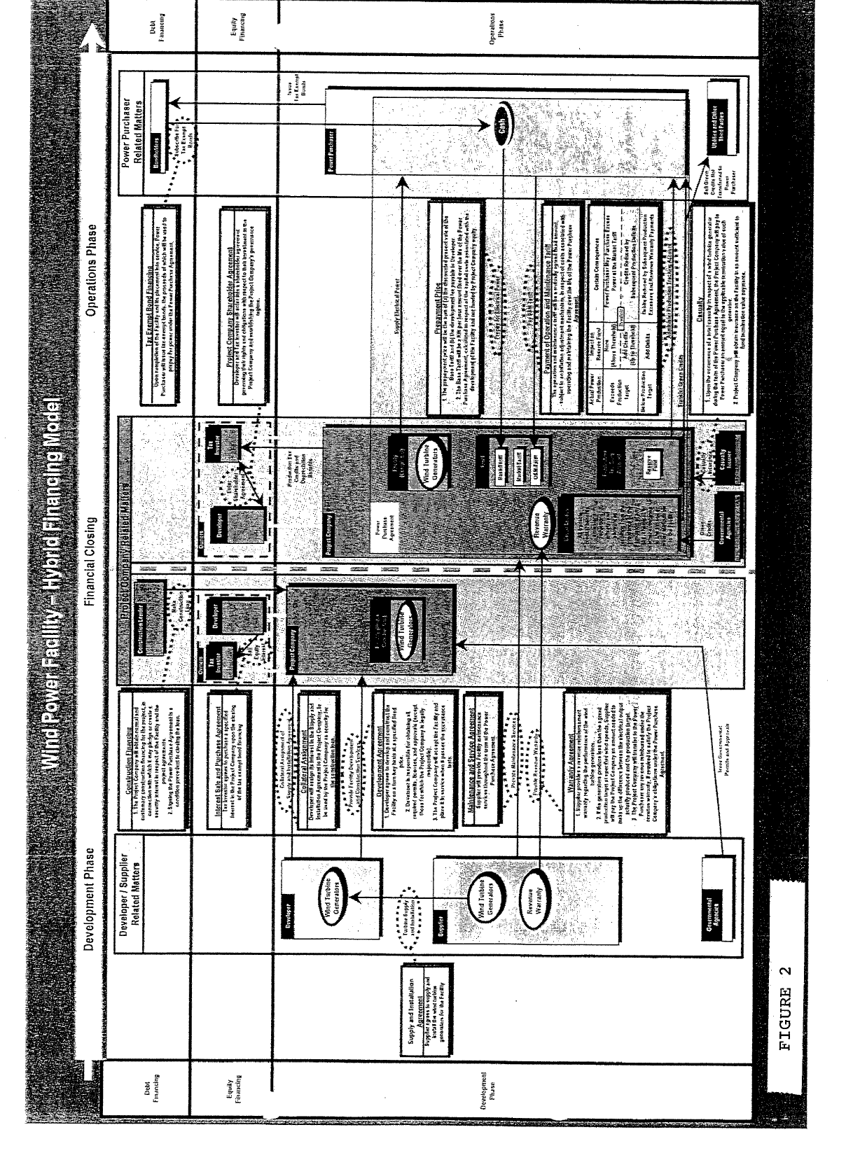

FIG. 2 shows a flow diagram of a exemplary hybrid financing structure for a wind power facility, in which the facility includes wind turbine generators for converting wind energy into electricity. This exemplary hybrid financing structure is not limited to wind power and can be applied to other types of renewable power facilities, e.g., solar power facility.

While the invention is susceptible to various modifications, and alternative forms, a specific example thereof has been shown in the drawings and is herein described in detail. For example, the Purchaser of power can be any municipality or other governmental entity able to use low cost debt financing, e.g., bonds, to prepay for the purchase of power from the Facility. Further, the renewable power Facility can be used any renewable energy resource which benefits from tax credits. Examples of renewable energy resources include the aforementioned solar energy and wind power, biomass which can be converted into electrical or heat energy, etc. It should be understood, however, that the invention is not to be limited to the particular forms or methods disclosed, but to the contrary, the invention is to cover all modifications, equivalents and alternatives falling within the spirit and scope appended claims.

What is claimed:

1. A method of reducing the cost of power from a renewable power facility comprising:
prepaying for power from the power facility for a period of time using low cost debt financing available to a purchaser;
using the prepayment of power to avoid the necessity of obtaining long term debt for the power facility; and
reducing the price for the prepayment of power using one or more cost reduction vehicles.

2. The method of claim 1 wherein the period of time is at least five years.

3. The method of claim 1, wherein the period of time is at least ten years.

4. The method of claim 1, wherein the low cost debt financing includes tax exempt bonds.

5. The method of claim 4, wherein the purchaser is a municipal utility.

6. The method of claim 1, wherein the prepayment of power is used to repay a construction loan used to fund construction of the power facility.

7. The method of claim 1, wherein one or more cost reduction vehicles includes tax deduction benefits.

8. The method of claim 1, wherein one or more cost reduction vehicles includes production tax credits.

9. The method of claim 1, further comprising:
establishing a production target;
comparing actual power production from the power facility to the production target;
if the actual power production exceeds the production target, crediting a production tracking account with an amount corresponding to the difference between the actual power production and the production target; and
if the actual power production is below the production target, debiting the production tracking account with an amount corresponding to the difference between the production target and the actual power production.

10. The method of claim 9, further comprising:
if the actual power production exceeds the production target, delivering excess power production to the purchaser at no additional charge.

11. The method of claim 10, further comprising:
reducing the period of time based on the amount of the excess power production delivered to the purchaser at no additional charge.

12. The method of claim 9, further comprising:
if the actual power production is below the targeted production, extending the period of time based on the amount that the actual power production is below the targeted production.

13. The method of claim 1, wherein the low cost debt financing includes taxable bonds.

14. The method of claim 1, wherein one or more cost reduction vehicles includes renewable energy credits and green credits.

15. A method of reducing the cost of power from a renewable power facility comprising:
prepaying for power from the power facility for a period of at least 5 years using low costs debt financing available to a purchaser; and
reducing the price for the prepayment of power using one or more cost reduction vehicles selected from the group consisting of tax depreciation benefits and tax production credits.

16. The method of claim 15, further comprising:
using the prepayment of power to repay a construction loan used to fund construction of the power facility.

17. The method of claim 15, wherein the low cost debt financing includes tax exempt bonds.

18. The method of claim 17, wherein the purchaser is a municipal utility.

19. The method of claim 15, wherein the low cost debt financing includes taxable bonds.

20. The method of claim 15, wherein the one or more cost reduction vehicles includes renewable energy tax credits and green credits.
